(19) United States
(12) Patent Application Publication
(10) Pub. No.: US 2010/0178120 A1
(43) Pub. Date: Jul. 15, 2010

(54) MACHINE TOOL HIGH PRESSURE FLUID DISTRIBUTION SYSTEM AND METHOD OF OPERATION THEREOF

(76) Inventor: Richard O. Packard, Burrillville, RI (US)

Correspondence Address: BARLOW, JOSEPHS & HOLMES, LTD., 101 DYER STREET, 5TH FLOOR, PROVIDENCE, RI, 02903, US

(21) Appl. No.: 12/685,308

(22) Filed: Jan. 11, 2010

Related U.S. Application Data
(60) Provisional application No. 61/143,451, filed on Jan. 9, 2009.

(51) Int. Cl. B23Q 11/10; G05D 7/00; G05D 16/00

(52) U.S. Cl. 408/56; 137/565.01; 137/14; 137/565.13; 137/565.15; 409/137

(57) ABSTRACT

A fluid distribution system for a machine tool is disclosed. The system includes a return and a filter in fluid communication with the return. A heat exchanger is in fluid communication with the filter. A pump is in fluid communication with the heat exchanger and a drive motor drives the pump. A valve is in fluid communication with the pump and a fluid distribution outlet. A controller is operatively connected to the drive motor and the valve.

### CROSS-REFERENCE TO RELATED APPLICATION

The present patent document claims priority to earlier filed Provisional Patent Application Ser. No. 61/143,451, filed on Jan. 9, 2009, the entire contents of which are incorporated herein by reference.

### BACKGROUND OF THE INVENTION

1. Field of the Invention

The present invention relates to coolant systems for machine tools and, more particularly, to an accessory, high pressure cooling fluid delivery system for machine tools.

2. Background of the Related Art

In general, machine tools are provided with integral cooling or lubricating systems which supply cooling or cutting fluid to the work stations of the machine tools. The cutting fluid generally reduces friction, draws heat away from the cutting tool and work piece and flushes the work site of debris. This generally improves control and accuracy of the machining process, increases production and reduces tool wear. However, the integral cooling systems of machine tools generally provide low pressure cutting fluid to the cutting area. The low pressure cutting fluid is inadequate for some operations of the machine tools to generate the desired cooling rates and flush away chips. Thus, for some operations a supplemental cooling fluid delivery system to provide high pressure cooling fluid to the cutting area of the machine tools is desirable. The supplemental cooling fluid delivery systems of the prior art generally provide a single coolant line directing high pressure cooling fluid to one work station. In the case more than one station was to be supplied by the prior art delivery systems, the cooling fluid from the single delivery line may have been split amongst several discharge nozzles resulting in lower pressures and/or reduced fluid flow at the nozzles in comparison to the pressure and flow in the single delivery line.

However even these systems suffer from several disadvantages. Current inventions produce excessive heat and degrade the repeating reliability of the machine tool. Also, these prior art system also lack safety controls to prevent the tool from exceeding component pressure limits, which could result in catastrophic failure if the component and resulting damage to the machine tool. Fluid hoses may also pulsate causing wear through of the hose and connector failure at the hose crimp.

Starter contacts often fail prematurely on these prior art machine tools as well. The prior art starter contacts fail prematurely because these starter contacts carry a high inductive load when the starter contacts are open. The high inductive load causes electrical arcing and premature wear of the starter contacts.

The filter system includes a number of disadvantages. First, the filter system is difficult to clean all the contaminated fluid from the filter assembly during a filter change, which could clog the distribution components of the system resulting in loss of pressure or dangerous overpressure of the clogged components. Air is often trapped in the top of the filter assembly, which can lead to undesirable cavitations and loss of pressure.

Prior art fluid distribution systems also suffer from the disadvantage that a custom quick change manifold must be installed for each machine tool.

Accordingly, there is a need within the industry for an improved machine tool fluid distribution system that solves these problems.

### SUMMARY OF THE INVENTION

The present invention overcomes the deficiencies of the prior art by providing a high pressure fluid delivery system for a machine tool that uniquely includes a control mechanism to provides distributed fluid directly to the tools and/or tool holders in the machine tool at the work stations at a pressure higher than that which is provided by the machine tool. Specifically, the system includes a frame, a variable displacement fluid pressure pump attached to a drive motor, a filter system, a heat exchanger, thermocouples, adjustable pressure regulator, pressure relief valves, solenoid valves, manifolds, pressure gauges, programmable logic controller (“PLC”) and distribution hoses.

An object of the present invention is a provision for a system and personal safety that prevents over pressurization.

Another object of the present invention is the provision for automatically depressurizing the filter assembly when the system is shut down for filter maintenance to improve safety.

Yet another object of the present invention is to simplify and improve the cleaning process of the filter canister during filter media replacement.

Another object of the present invention is the provision for reducing energy consumption by sequencing the starting and stopping of the pump with the opening and closing of the valves.

Another object of the present invention is the provision for increasing the hose life by sequencing the starting and stopping of the pump with the opening and closing of the valves.

Yet another object of the present invention is the provision for reducing power consumption by constantly adjusting fluid volume to maintain set pressure.

Another object of the present invention is the provision for reducing procurement cost by incorporating a constant RPM variable volume pump.

### BRIEF DESCRIPTION OF THE DRAWINGS

These and other features, aspects, and advantages of the present invention will become better understood with reference to the following description, appended claims, and accompanying drawings where:

FIG. 1 is a perspective view of a preferred embodiment of the fluid distribution system of the present invention;

FIG. 2 is a perspective view of the fluid distribution system of the present invention shown connected to a machine tool;

FIG. 3 is a schematic diagram showing how the preferred embodiment of the fluid distribution system of the present invention operates;

FIGS. 4A-F forms a flow diagram of Ladder Code showing how the preferred embodiment of the fluid distribution system of the present invention is programmed.

### BRIEF DESCRIPTION OF THE PARTS OF THE SYSTEM

The following parts are included in the system as shown in the schematic diagram of FIG. 3:

1. Alarm circuit

2. Machine tool relay outputs

3. Pressure warning circuit

4. Vacuum alarm circuit

5. Pump motor control circuit

6. Solenoid control circuits

7. Thermocouple circuit

8. Programmable logic controller

9. Heat exchanger with thermocouple

10. Filter

11. Pressure gauge (filter inlet)

12. Pressure/vacuum gauge (filter outlet)

13. Solenoid operated valves

14. Adjustable pressure relief valve

15. Pump drive motor

16. (A) Fixed volume pump, 16. (B) Variable volume pump

17. Solenoid operated pressure relief valve

18. Preset tamper proof pressure relief valve

19. Coolant supply from machine tool flood coolant system

20. Return to machine tool coolant sump

21. Filter vent

22. Filter drain valve

23. Coolant distribution lines

24. System indicator lamps and reset

25. High pressure switch

26. Pressure switch

27. Vacuum switch

28. High pressure gauge

102. Machine tool

### DESCRIPTION OF THE PREFERRED EMBODIMENT

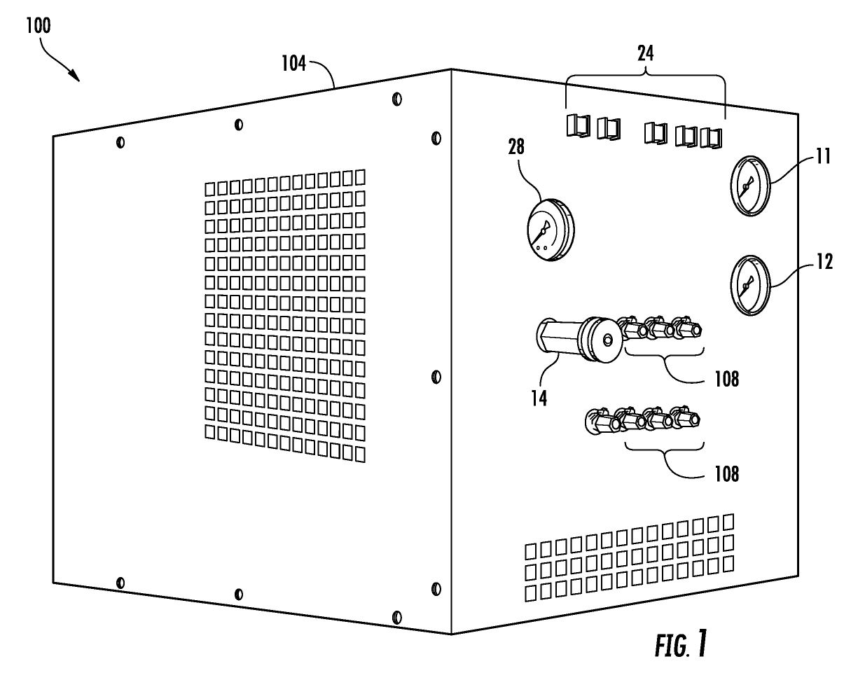

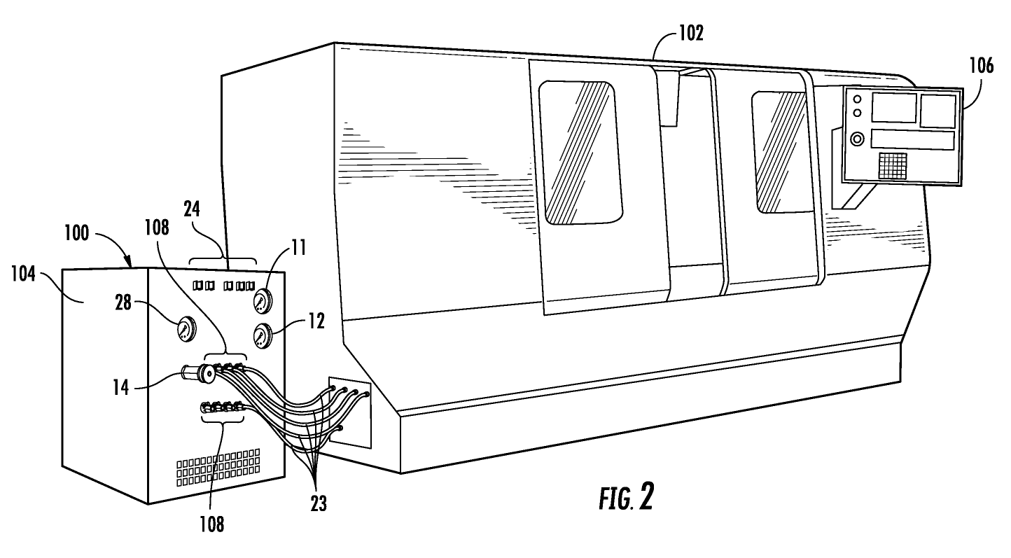

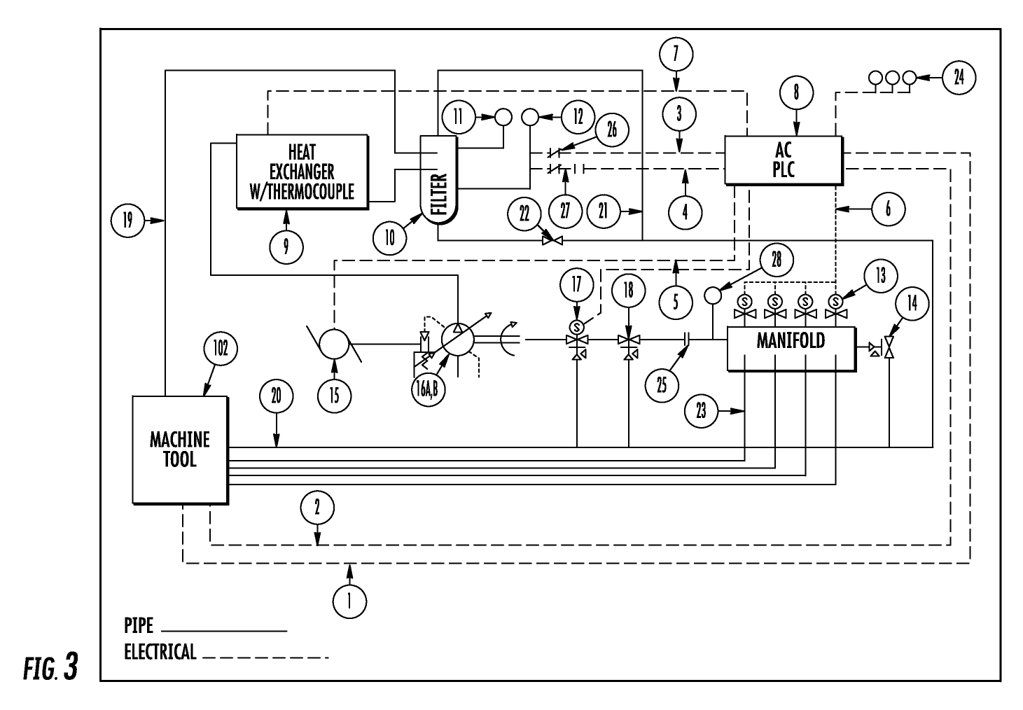

Referring now to FIGS. 1-3, a high pressure fluid distribution system 100 that provides fluid directly to the tools and/or tool holders in the machine tool 102 at the work stations at a pressure higher than that which is provided by the machine tool 102 itself is disclosed.

The system 100 of the present invention includes a frame 104, a drive motor 15 configured and arranged to drive a fluid pressure pump 16, a filter system 10, 21, 22, a heat exchanger 9, thermocouples, adjustable pressure regulator 14, pressure relief valves 17, 18, solenoid valves 13, manifolds, pressure gauges 11, 12, 28, distribution hoses (or pipes) 19, 20, 21, 23 and a programmable logic controller (“PLC” or “controller”) 8. These components and the manner of their interconnection will be further described below.

The machine tool processor reads the specific code, which is input to the machine tool 102 via the machine tool integrated keyboard or other connected input device 106, and controls the work stations within the machine tool 102; to perform specific movements and to open and close specific contacts.

The opening and closing of the specific machine tool contacts energizes and de-energizes the coils of the PLC 8. The present invention includes a transient voltage suppressor at each PLC contact and at each motor starter contact thereby trapping the high inductive load and reducing electrical arcing of the contacts. By reducing the electrical arcing of the PLC and motor starter contacts, useable life of those contacts is prolonged.

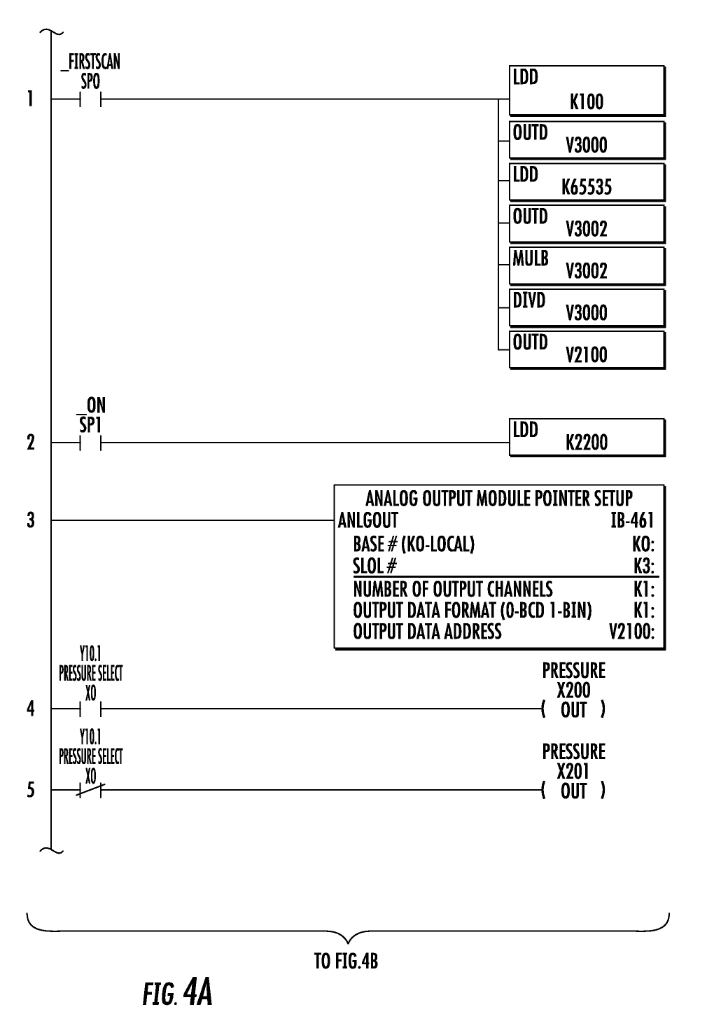

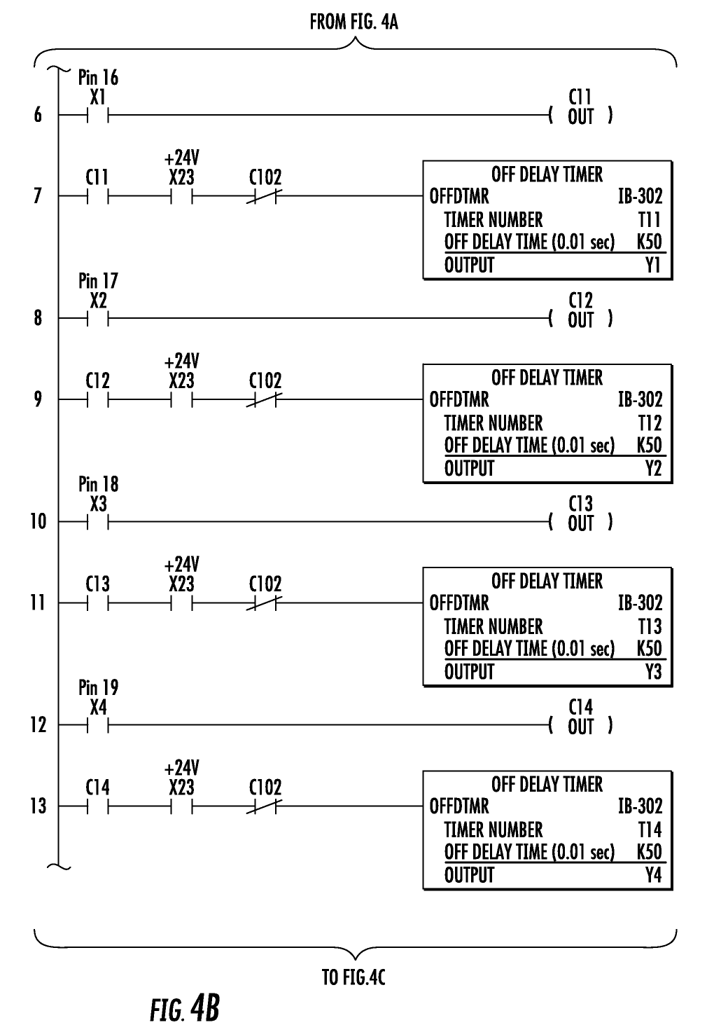

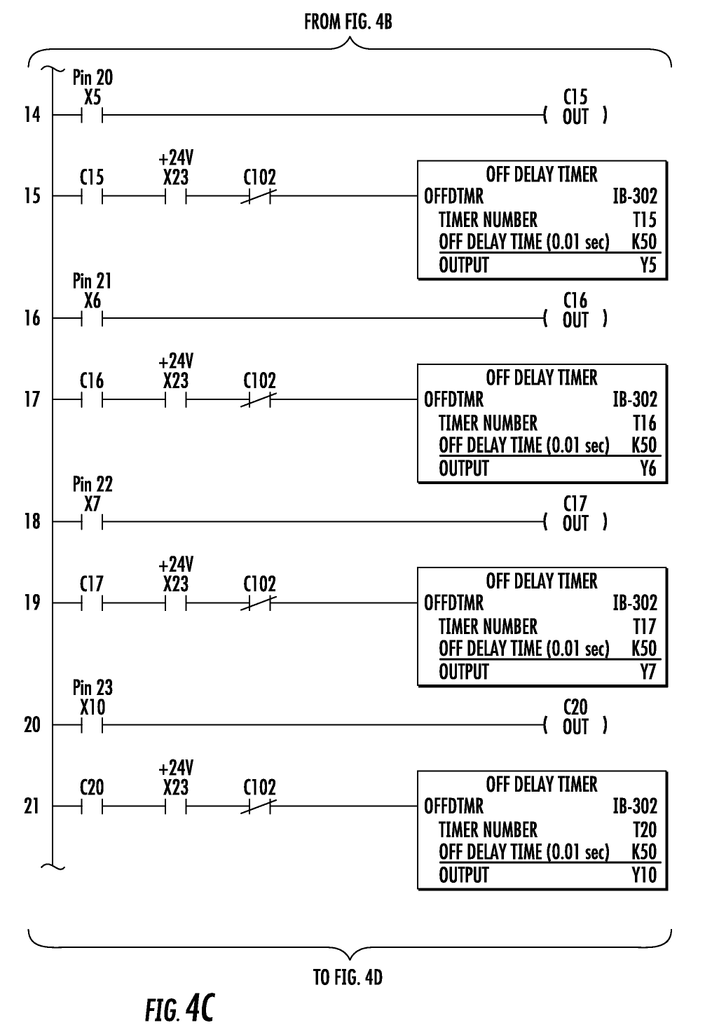

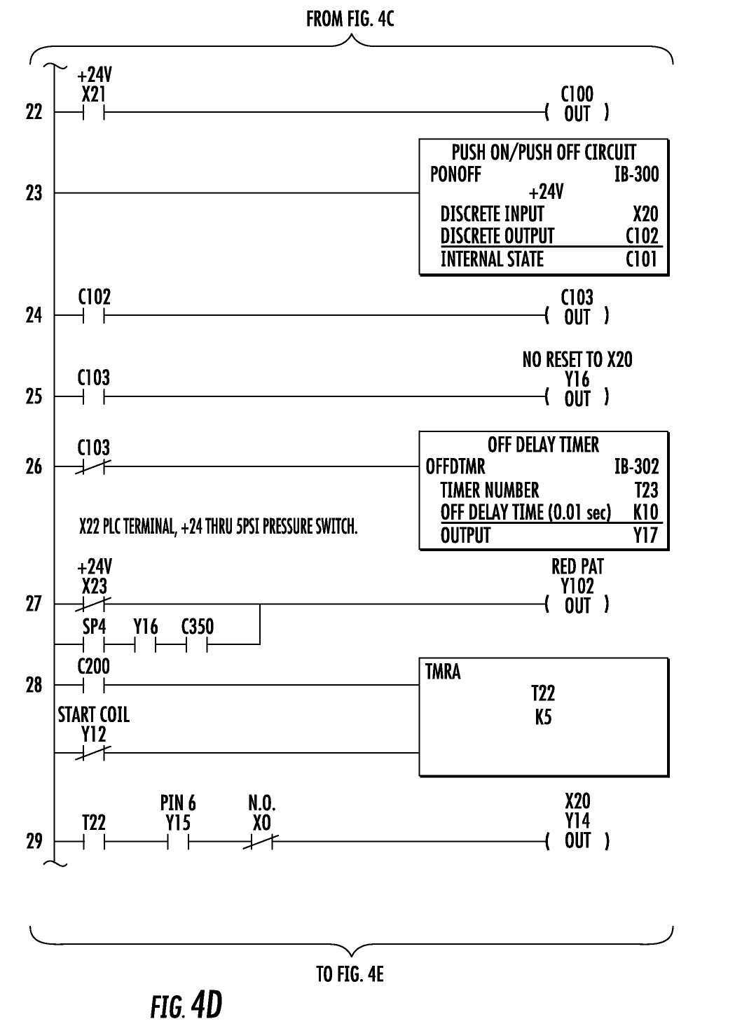

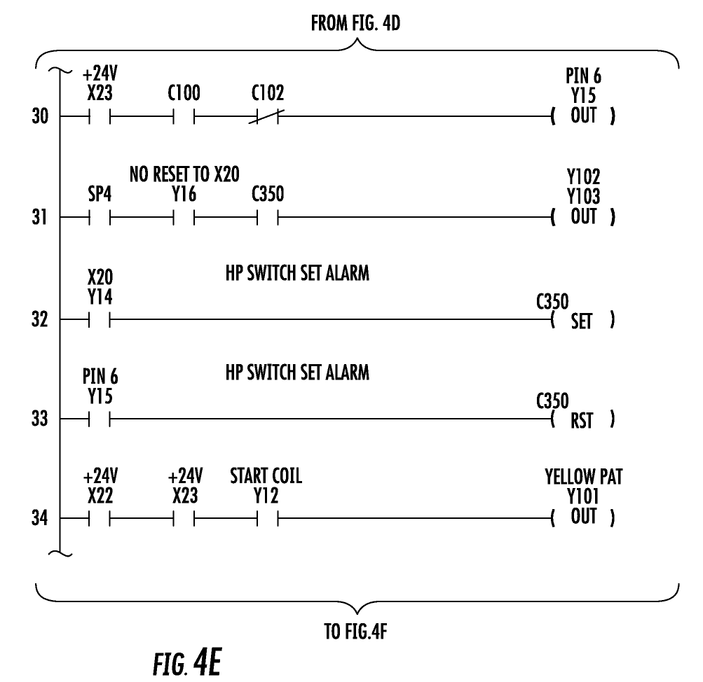

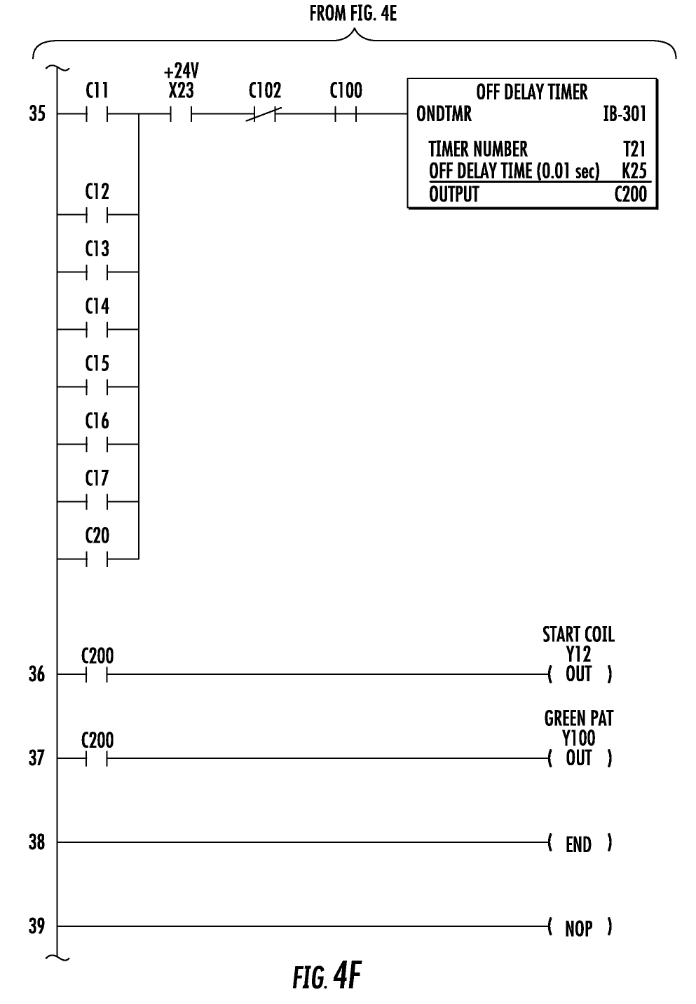

The energizing and the de-energizing of the coils perform a specific independent predetermined functions which include but not limited to the sequential starting and stopping of the pump drive motor and the sequential opening and closing of the solenoid valves. Referring to FIGS. 4A-F, a diagram of Ladder code (or also referred to as a Ladder diagram or Sequential Function Chart) shows an exemplary method of operation of the high pressure fluid distribution system of the present invention.

The distribution hoses are attached directly to the machine tool with bulkhead connectors and the internal flexible hoses are routed from the individual bulkhead connectors directly to the cutting tool, forming tools or their tool-holders.

As will be further described below with reference to FIGS. 4A-F and the Ladder Code, the sequence and timing of each function of the system is critical to the safety of the system and personnel and the longevity of the components. The system monitors the filter pressure and executes either a warning for impending filter failure or an alarm for filter failure. The system also monitors the fluid temperature and engages and disengages the heat exchanger and fluid return to maintain fluid temperature.

As will be further described below, the alarm status of the machine tool prevents the high pressure fluid distribution system from being operated with the machine tool in alarm status and monitors the operation of the system to provide the machine tool with a ready or alarm indicator.

Turning now to the Schematic Diagram, the machine tool is connected electrically 1, 2 to a PLC 8. The coolant is supplied to the system by the machine tool by a flood coolant pump 19 to the input side of the filter 10. The output side of the filter 10 is connected to the input side of a heat exchanger 9. A thermocouple connected to the heat exchanger 9 measures the output temperature of the fluid. The thermocouple is connected electrically to the PLC 8 and energizes and de-energizes the cooling apparatus of the heat exchanger 9 to maintain a preset fluid temperature. The output side of the heat exchanger 9 is connected to the high pressure pump 16A (or 16B) which may either be a fixed volume pump 16A or a variable volume pump 16B as desired.

A pressure gauge 11 measures the input pressure of the filter 10 and a pressure/vacuum gauge 12 measures the pressure on the output of the filter 10. A preset pressure switch is connected electrically to the PLC 8 and illuminates a warning lamp 24 when the filter 10 output pressure falls below the preset pressure. A vacuum switch 27 is connected electrically to the PLC 8 and sets the alarm circuit 1 when the filter output pressure is at the preset vacuum.

The machine tool 102 is connected electrically 1 to energize and de-energize the coils of the PLC 8 and an alarm circuit 2, which provides an alarm signal to the machine tool 102 when the system 100 has a thermal over load, clogged filter, power loss or pressure loss.

The energizing of the PLC 8 input coils by electrical signal from the machine tool starts a sequence of events by the PLC 8. If no alarm exists the assigned solenoid value 13 opens and with a time delay the pump motor 15 starts and powers the pump, fixed volume 16A or variable volume 16B. The high pressure pump fixed volume 16A is connected to a preset tamper-proof pressure relief valve 18. A variable volume pump 16B is connected to a solenoid operated manually single setting pressure relief valve 17 (or an electrically settable pressure relief valve) and then to a preset tamper-proof pressure relief valve 18 and is connected to solenoid valves 13. A pressure switch 25, which is connected electrically to the alarm circuit 1 through the PLC 8, detects the presence of pressure in the fluid circuit. When a fixed volume pump 16A is used a manually adjustable pressure relief valve 14 sets the pressure to the coolant distribution lines 23 and returns excess fluid to the return 20. The solenoid operated pressure relief valves 17, preset tamper proof pressure relief valve 18, filter vent 21 and the filter drain valve 22 are connected to the return 20.

The de-energizing of the PLC 8 input coils by an electrical signal from the machine tool 102 starts a sequence of events by the PLC 8.

If only one solenoid valve is open, the pump drive motor 15 is de-energized and with a time delay the assigned solenoid valve 13 closes.

If more than one solenoid valve 13 is open only the assigned solenoid valve 13 is closes.

When the PLC 8 sets an alarm signal 1 to the machine tool 102, the alarm must be cleared and reset before the system 100 will resume a manual or automatic operation.

Filter media replacement is accomplished by disconnecting the system's 100 power supply, opening filter drain valve 22 and opening the filter cover. The filter vent 21 relieves the pressure within the filter system and creates a safe condition for opening the filter cover. When the coolant has drained from the filter 10, the filter media is removed and replaced with new filter media and the cover is closed and secured. With the filter drain valve 22 open the machine tool fluid coolant is turned on flushing all the contaminants thru the filter drain valve 22 to the return 20 with filtered coolant.

The filter drain valve 22 remains open until all the trapped air is vented thru the clear tube filter vent 21. Because the trapped air is vented out of the system, undesirable foaming of the coolant is prevented during normal operation of the system.

Turning to the Ladder Code now in FIGS. 4A-F, input coils X1, X2, X3, X4, X5, X6, X7 and X10 are energized and de-energized by the machine tool 102 relay outputs 2 and they open and close the internal PLC 8 coils C11, C12, C13 C14, C15, C16, C17 and C20.

These internal coils start the off delay timers which are electrically connected to the solenoid valves 13 and are connected as a logical “or” coil to the on delay timer for the pump drive motor 15. The delay timers essentially open the solenoid valves 13 prior to the pump 16 starting and stops the pump 16 prior to the pump closing of the solenoid valves 13, which prevents cavitations in the pump 16A, 16B and also pulsating of the coolant fluid distribution lines 23.

C11, C12, C13, C14, C15, C16, C17 and C20 are connected with a logical “and” contact to the pump drive motor 15 thermal overload, preset vacuum switch 27 and high pressure switch 25.

Inputs X11 and X12 are energized and de-energized by the machine tool relay outputs 2 and they activate the solenoid operated pressure relief valves 17 to supply preset fluid pressure to the coolant distribution lines 23. In this manner, a constant preset pressure is maintained throughout the fluid distribution system.

A digital input through the machine tool relay outputs 2 is supplied from the machine tool 102 to the PLC 8 to electrically adjust the operating pressure of the fluid to the coolant distribution lines 23.

Also included on the frame are a number of indicator lamps to display the various alarms and warnings described above and three pressure gauges. In particular, a high pressure gauge 28 is provided to measure the overall output pressure of the system 100. Also provided are a filter input pressure gauge 11 and a filter output pressure gauge 12. The filter input and output pressure gauges 11, 12 measure the pressure at the input and output of the filter 10, respectively, thereby providing the operator of the system with valuable information on whether the filter 10 is operating within acceptable tolerances. A large discrepancy between the two filter pressure gauges 11, 12 may indicate a blockage in the filter 10 or some other malfunction.

Also proved is a pressure adjusting valve 14, which can be manually adjusted to set the overall output pressure of the system 100.

Several coolant outlets 108 to connect to the coolant distribution lines 23 are provided on the frame as well, for the convenience of the operator.

Therefore, it can be seen that the present invention provides a unique solution to the multiple problems of maintain fluid temperature in a machine tool, improving system safety in a fluid distribution system, including a clogged filter warning and alarm. Moreover the system further provides for easy and effective method of changing the filter bag and cleaning the filter vessel. The improved filter assembly further provides for continuous removal of trapped air at the top of the filter assembly, thereby preventing foaming of the coolant. The sequencing of the energizing of the solenoid valves further eliminates high pressure pulsating of the hoses. The fluid distribution system of the present invention further provides for improved motor starter contact life. The system further eliminates user-formed nozzles and tubing to provide an efficient, reliable, consistent method to direct fluid to the cutting tool point of contact. Furthermore, the programming of the fluid distribution system of the present invention further provides for reduced energy consumption.

It would be appreciated by those skilled in the art that various changes and modifications can be made to the illustrated embodiments without departing from the spirit of the present invention. All such modifications and changes are intended to be within the scope of the present invention except insofar as limited by the appended claims.

What is claimed is:

1. A fluid distribution system for a machine tool, comprising:
a return;
a filter in fluid communication with the return;
a heat exchanger in fluid communication with the filter;
a pump in fluid communication with the heat exchanger;
a drive motor driving the pump;
a valve in fluid communication with the pump;
a fluid distribution outlet in fluid communication with the valve; and
a controller operatively connected to the drive motor and the valve.

2. The system of claim 1, wherein the pump is a fixed volume pump.

3. The system of claim 1, wherein the pump is a variable volume pump.

4. The system of claim 1, further comprising a transient voltage suppressor operatively connected to a contact of the controller.

5. The system of claim 1, further comprising a transient voltage suppressor operatively connected to a motor starter contact of the drive motor.

6. The system of claim 1, further comprising a temperature sensor operatively connected to the heat exchanger and the controller.

7. The system of claim 1, wherein the temperature sensor is a thermocouple.

8. The system of claim 1, further comprising a pressure gauge in fluid communication with the filter and operatively connected to the controller.

9. The system of claim 1, further comprising an alarm circuit operatively connected to the controller and to a machine tool.

10. The system of claim 1, further comprising an adjustable pressure relief valve in fluid communication with the fluid distribution outlet and the return, the adjustable pressure relief valve configured and arranged to adjust the pressure of a fluid being pumped by the pump.

11. The system of claim 1, further comprising a pressure relief valve in fluid communication to the pump and to the return and operative to relieve excess fluid pressure from the pump.

12. The system of claim 11, wherein the pressure relief valve is a solenoid operated manually single setting pressure relief valve operatively connected to the controller.

13. The system of claim 11, wherein the pressure relief valve is an electrically settable pressure relief valve operatively connected to the controller.

14. The system of claim 11, further comprising a tamper-proof pressure relief valve in fluid communication with the pump and the return and operative to relieve excess fluid pressure from the pump.

15. The system of claim 1, wherein the valve is a solenoid operated valve.

16. The system of claim 1, further comprising a filter drain valve in fluid communication with the filter and the return.

17. The system of claim 1, further comprising a filter vent in fluid communication with the filter and the return.

18. A method of operating a fluid distribution system for a machine tool, the fluid distribution system having a drive motor driving a pump and a valve connected to the pump, the method comprising:
opening a valve connected to a pump and distribution lines connected to a machine tool to distribute coolant fluid thereto prior to starting a drive motor;
starting the drive motor to drive the pump to pump coolant fluid through the distribution lines to the machine tool and back through a return in fluid communication to the pump, the machine tool pump, the return, the valve and distribution lines forming a fluid path for the coolant fluid;
stopping the drive motor prior to closing the valve; and
closing the valve.

19. The method of claim 18, further comprising:
modulating a pressure relief valve connected between the pump and the return to maintain a constant pressure from the pump by controlling the flow of coolant fluid therethrough.

20. A method of continuously purging air from a filter assembly for a fluid distribution system of a machine tool, comprising:
providing a filter vent connected between a filter assembly and a return; and
operating a pump to circulate coolant fluid through the return and filter assembly and through distribution lines to the machine tool to vent air through the filter vent.
